(19) United States
(12) Patent Application Publication
(10) Pub. No.: US 2008/0165774 A1
(43) Pub. Date: Jul. 10, 2008

(54) INTER-NETWORK PACKET MODIFIER AND RELATED METHOD THEREOF

(76) Inventors: Chien-Chung Huang, San Jose, CA (US); Yuan-Liang Cheng, San Jose, CA (US); Tung-Hao Huang, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/619,620

(22) Filed: Jan. 4, 2007

(51) Int. Cl. H04L 12/56

(52) U.S. Cl. 370/392; 370/429

(57) ABSTRACT

An inter-network packet modifier coupled between a first network and a second network for generating an outgoing transport packet forwarded to the second network according to an incoming transport packet received from the first network is disclosed. The inter-network packet modifier includes: a storage device for storing an updated identification information; and a pattern detector for detecting a specific pattern of the incoming transport packet and for exchanging an original identification information of the incoming transport packet with the updated identification information according to the specific pattern to generate the outgoing transport packet; wherein the pattern detector is a dedicated hardware for identification information exchanging.

### BACKGROUND

The invention relates to an apparatus and method of handling inter-network data flow, and more particularly, to a dedicated inter-network packet modifier and related method thereof.

A digital TV signal is transmitted as a stream of MPEG-2 data known as a transport stream. Each transport stream has a data rate of up to 40 megabits/second for a cable or satellite network, or approximately 20 megabits/second for a terrestrial network, which is enough for seven or eight individual TV channels.

Please refer to FIG. 1, which illustrates how transport streams are formed. Basically, original audio and video digital signals (video source 102v and audio source 102a) are encoded by respective encoders 104v and 104a to form video and audio elementary streams (ES) according to an encoding scheme (e.g. MPEG standard). In addition to audio and video signals, some sort of data, e.g. private data, teletext information, are also needed to be included. Data from a data source 102d will form a data elementary stream. These elementary streams cannot be directly transferred or stored, however. The elementary streams further forward into a packetizer 106 to be packetized. In other words, these streams are split and form packets in order to make the multiplexing process easier. The result of this is a packetized elementary stream, (PES). In addition to audio and video data, PES typically includes data streams for applications, Teletext information, or other functions.

Finally, the PES (including the video PES and audio PES) are multiplexed by the multiplexer 108 into a program stream (PS) or a transport stream (TS), and then to be stored or transmitted.

The TS, due to its short packet structure, is capable of transmitting through noisy communication environment for its higher immunity against communication errors. The length of a transport packet is fixed, that extra parity information can be added for error correction. Please note that a packet of the above-mentioned PES can correspond to different sizes. Therefore, a PES packet may be split into short sections, each section is further packetized as a transport packet, and concatenated as a transport stream.

It is well known that digital TV signals are transmitted using MPEG-2 Transport Stream consisting of a plurality of transport packets. Length of each transport packet is fixed at 188 bytes, which contains a 4-byte header, an optional adaptation field, and a payload for carrying either encoded (e.g. MPEG) video, encoded (e.g. MPEG) audio, data, or service information. Several of the important header fields are described here, including the Sync byte field and the 13-bit packet identifier (PID) field. The Sync byte can be used to establish the packet boundaries to allow random access into the transport stream. The PID identifies transport packets belonging to the one and the same data stream, making it possible to reconstruct the stream within the Set Top Box (STB). Transport packets stamped with a same PID are considered as a PID stream. As an example, a program commonly associated with at least one audio and one video stream. Transport packets containing an audio stream are identified by a unique audio PID. Likewise, transport packets containing a video stream are identified by a unique video PID.

Since each transport packet of the transport stream may carry information as encoded (e.g. MPEG) video, encoded (e.g. MPEG) audio, control information or service information, the information carried by the transport packet must be identified and extracted. The extracted information is recombined to produce the original information to present to the users (for example, showing a TV program). In order to obtain this purpose, the MPEG standard specifies information added to the transport stream beside video and audio, known as “service information” to provide the necessary information for the above-mentioned task.

Service information describes the structure of the transport stream. Some service information contains table for describing services (i.e. TV programs) provided by the transport stream. The table lists a set of PID streams associated with the service, the corresponding PID, and the type of data contained in each PID streams. Based on the service information, the receiver identifies which PID stream containing audio, video, or other types of data and applies different decoding schemes accordingly.

Some of service information are tied to specific services, while some are more general and describe either the structure of the transport stream or properties of the network. In some cases, PID stream containing Si corresponds to a fixed PID for decoders easier to find, while in other cases PID stream containing Si corresponding to a PID which is described in another Si table.

For example, the Si tables that are commonly found in a DVB transport stream are:

Program Association table (PAT)—defined by the MPEG standard

Program Map Table (PMT)—defined by the MPEG standard

Conditional Access Table (CAT) defined by MPEG standard

Network Information Table (NIT)

Service Description Table (SDT)

Event Information Table (EIT)

Bouquet Association Table (BAT)

Time and Date Table (TDT)

Time Offset Table (TOT)

The Program Association Table is the fundamental table for service information. It describes PID corresponding to the Program Map Table associated with each service provided by the transport stream (see below).

The Conditional Access Table describes the CA systems that are in use in the transport stream, and provides information about the conditional access management and type of scrambling.

The Program Map Table lists a set of PID streams associated with a service, also the PID stream containing the MPEG Program Clock Reference for the service. The PMT is not corresponding to a fixed PID, and each service provided by the transport stream has its corresponding PMT.

Together, the PAT, PMT, and CAT are known as Program Specific Information (PSI), which are defined by MPEG standard. All other tables are specific to DVB systems and known by those skilled in the art, so they are omitted here.

Please refer to FIG. 2, which is a diagram of a transport stream 100. As shown in FIG. 2, the transport stream comprises PID streams 1001˜1009. The first PID stream with PID 00 comprises a Program Association Table (PAT), which is service information. The Program Association Table (PAT) can be utilized to indicate other service information such as the Program Map Table (PMT). In other words, the packet association table lists the PID corresponding to each Program Map Table (PMT). Please refer to the PAT shown in FIG. 1, which shows two PMTs contained in PID streams corresponding to PID 200 and 201 respectively. Each PMT associates with a service (here, the service can be regarded as a program or a TV channel). Therefore the PAT somehow is a TV program/channel list, and each PMT indicates transport packets associated with one TV program/channel. In this example, for service 1, the PMT corresponding to the PID 200 shows that the PID streams having the PID 100, 102, and 106 contain video data, audio data, and other data respectively. These PID streams can therefore be recombined to join the encoded video, audio, and data together, allowing the TV channel to be presented to the user. On the other hand, for service 2, the PMT corresponding to the PID 201 shows that the PID streams having the PID 101, 103, and 104 contain video data, audio data, and other data respectively. These PID streams can therefore be recombined to join the encoded video, audio, and data together, allowing the TV channel to be presented to the user.

There will be problems, however, when the transport stream is transferred from a first network to a second network, the service information contained in the transport stream has to be changed in order to comply with the requirement of the second network. Please note that the above-mentioned network is a communication network supporting the transmission of the transport stream, such as an entity (e.g. a user's satellite or cable operator) which provides the transmission of the transport stream. In terrestrial systems, several networks activate at the same time in the same area (e.g. several national networks, plus one or more regional operators). In a cable TV system, if a standard TV receives a TV signal from the cable, the TV is commonly capable of receiving all the TV channels carried by the TV signal. But, if the TV signal has to be transmitted through a specific interface (such as IEEE 1394 or USB interface) to reach a target receiver, however, the target receiver is affordable of receiving and displaying limited numbers of programs or TV channels, due to the requirement/capability of the receiver. Therefore, the transport stream needs to be modified to have PAT and PMT according to the requirement/capability of the target receiver.

An inter-network packet modifier (such as a set top box) is utilized to deal with the above-mentioned tasks. Please refer to FIG. 3, which is a diagram of an inter-network packet modifier 20 according to the related art. As shown in FIG. 3, the inter-network packet modifier 20 comprises an identification filter 21, a direct memory access (DMA) controller 22 coupled to the identification filter 21, a memory 23 coupled to the DMA controller 22, a central controlling unit (CPU) 24 coupled to the DMA controller 22 and the identification filter 21, and a second DMA controller 26 coupled to the CPU 24. First of all, the identification filter 21 receives the TV signal (transport stream) from a first network 25 through a cable, IP, satellite, or Free-to-Air (Terrestrial) interface. The identification filter 21 selects only a few PID streams out of the transport streams. As mentioned above, the different PID streams may carry different information. The audio information will be used herein for illustration. For a TV program, different audio PID streams may carry audio information for the TV program in different languages. If only a few languages are required, the identification filter 21 may filter out unselected PID streams corresponding to the unselected languages.

The filtered transport packets are then output by the identification filter 21 and stored in the memory 23 through the DMA controller 22. The CPU 24 prepares an updated identification information for the second receiver, including modified PAT and PMT. The modified PAT only contains limited numbers of program links, depending on the requirement/capability of the target receiver 30. The PMT contains PID lists associated with the programs required by the target receiver. The CPU 24 also controls the DMA controller 22 to store the updated identification information in the memory 23. Please refer to FIG. 2 in conjunction with FIG. 1. The target receiver 30 capable of receiving only one TV program, only one program can be delivered through the connection, such that The PAT only contains one link to a PMT. Furthermore, because some of the transport packets are filtered out by the identification filter 21, the PMT also has to be changed correspondingly. Therefore, the CPU 24 controls the DMA controller 26 to read the entire transport stream from the memory 23, and exchanges the original identification information with the updated identification information according to each PID. The CPU 24 then forwards the exchanged transport stream to the target receiver 30 through the DMA controller 26 so that the target receiver 30 can process the selected program.

Please note that the DMA controller 22 and the DMA controller 26 can be the same DMA controller, i.e. they are both utilized for accessing data, but have different DMA operations.

Unfortunately, another problem occurs. In the above-mentioned inter-network packet modifier, all tasks rely on the CPU 24. As mentioned previously, the CPU 24 needs to execute many programs to deal with the packet exchanging and the flow control. Furthermore, the CPU 24 has to read the PAT and PMT information inefficiently on as byte by byte basis. These processes all rely on the CPU's resources. The CPU 24 may possibly output the transport stream unstably because the heavy loading of CPU 24. In other words, a “jitter” phenomenon may occur due to the CPU 24 can not serve in time, which could affect the quality of the receiver side program quality.

### SUMMARY

It is therefore one of the primary objectives of the claimed invention to provide a dedicated inter-network packet modifier and related method, to solve the above-mentioned problem.

According to an exemplary embodiment of the claimed invention, an inter-network packet modifier coupled between a first network and target network is disclosed. The inter-network packet modifier comprises: a storage device for storing an updated identification information; and a pattern detector for detecting a specific pattern of the incoming transport packets, and for exchanging an original identification information of the incoming transport packet with the updated content according to the specific pattern for generating the outgoing transport packet; wherein the inter-network packet modifier is a dedicated hardware for identification information exchanging. Any transport packet that does not match the specific pattern will by-pass the exchanging logic and forward to the target receiver.

According to another exemplary embodiment of the claimed invention, an inter-network packet exchanging method for generating an outgoing transport stream outputted to a target receiver according to an incoming transport stream received from a first network is disclosed. The inter-network packet exchanging method comprises: providing an inter-network packet modifier comprising a storage device and a pattern detector; utilizing the storage device to store an updated identification information; and utilizing the pattern detector to detect a specific pattern of the incoming transport stream and to exchange an original identification information of the incoming transport stream with the updated identification information according to the specific pattern for generating the outgoing transport stream; where if any transport packets do not match the specific pattern they will by-pass the exchange logic and forward to the target receiver; wherein the inter-network packet modifier is a dedicated hardware for packet exchanging.

The present invention inter-network packet modifier and related method can utilize a dedicated pattern detector to exchange the identification information of a transport stream. Therefore, the present invention can avoid the jitter phenomenon and improve the quality of a TV channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating how a transport stream is generated.

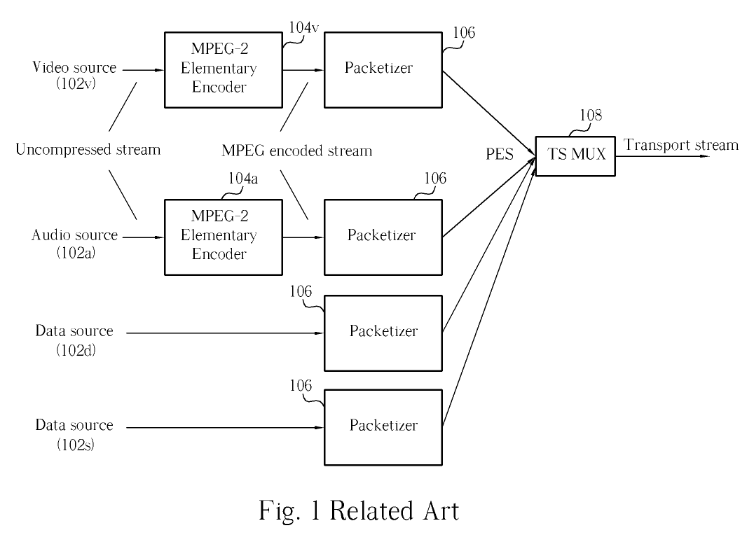

FIG. 2 is a diagram of a transport stream according to the related art.

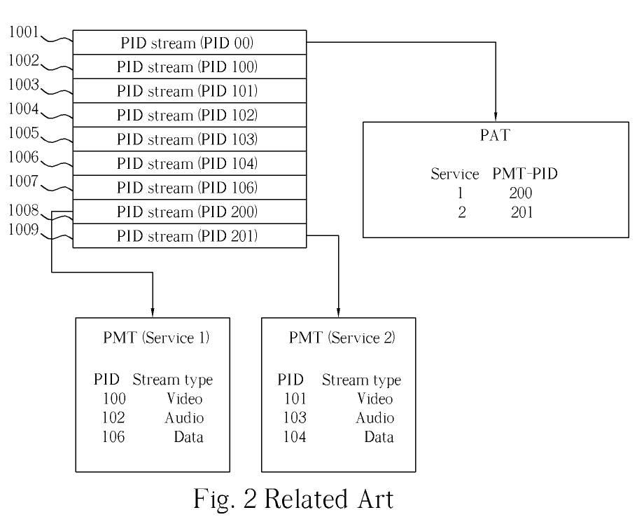

FIG. 3 is a diagram of an inter-network packet modifier according to the related art.

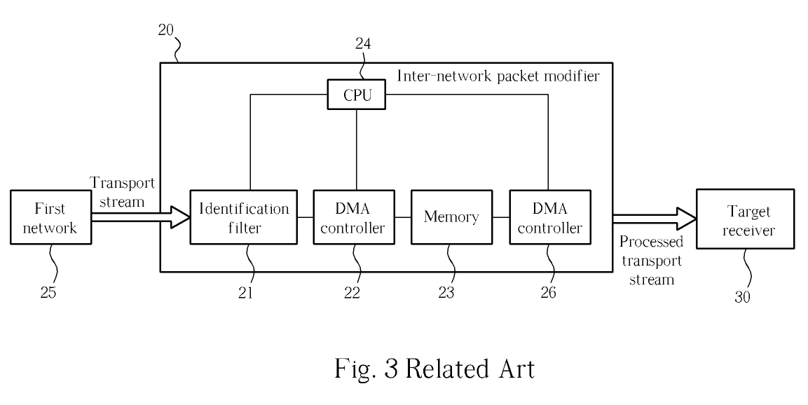

FIG. 4 is a diagram of an inter-network packet modifier of a first embodiment according to the present invention.

FIG. 5 is a flow chart illustrating the inter-network packet modifier shown in FIG. 4 performing the operation of exchanging the identification information of the transport stream.

FIG. 6 is a diagram of an inter-network packet modifier of a second embodiment according to the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

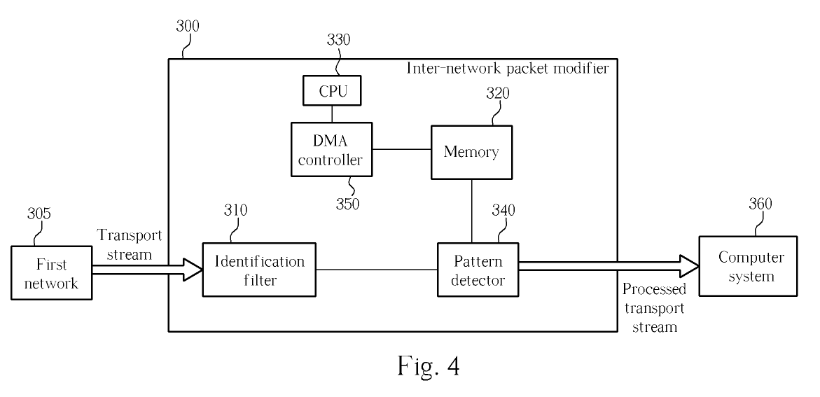

Please refer to FIG. 4, which is a diagram of an inter-network packet modifier 300 of a first embodiment according to the present invention. As shown in FIG. 4, the inter-network packet modifier 300 is similar to the inter-network packet modifier 20. The inter-network packet modifier 300 also comprises an identification filter 310, a memory 320, a CPU 330, and a DMA controller 350 coupled to the memory 320 and the CPU 330. The difference between the two inter-network packet modifiers is that the inter-network packet modifier 300 further comprises a pattern detector 340, which is coupled to the identification filter 310 and the memory 320. Please note that the pattern detector 340 is a dedicated device for exchanging the identification information of the transport stream. The operation and the function of the inter-network packet modifier 300 will be illustrated as follows.

In this embodiment, the inter-network packet modifier 300 is utilized to do the identification information exchanging on the transport stream transmitted between a cable TV system (which can be regarded as a first network 305) and a computer system 360 (which can be regarded as a second network).

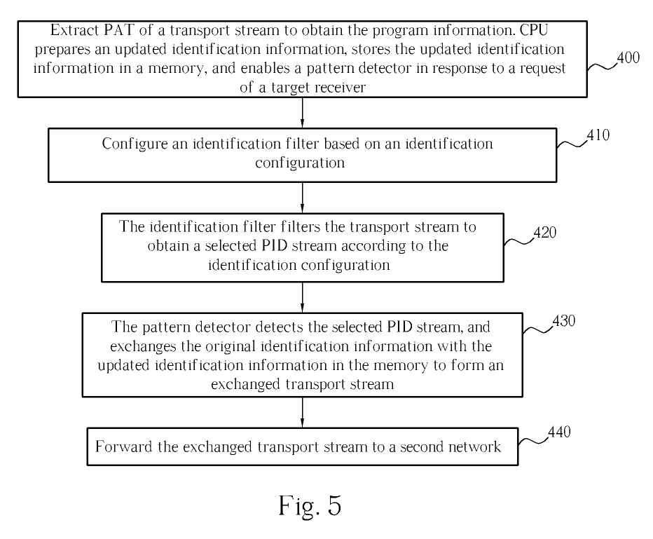

Please refer to FIG. 5, which is a flow chart illustrating the inter-network packet modifier 300 shown in FIG. 4 performing the operation of exchanging the identification information of the transport stream. The flow chart comprises the following steps.

Step 400: Extract PAT of a transport stream to obtain the program information. CPU 330 prepares an updated identification information, and stores the updated identification information in memory 320 and enables pattern detector 340 in response to the request of a target receiver;

Step 410: Configure identification filter 310 based on an identification configuration;

Step 420: Identification filter 310 filters the transport stream, to obtain a selected PID stream according to the identification configuration;

Step 430: Pattern detector 340 detects the selected PID stream, and exchanges the original identification information with the updated identification information stored in the memory 320, to form an exchanged transport stream.

Step 440: Forward the exchanged transport stream to second network 360.

First of all, the PAT is extracted from the transport stream to obtain channel/program information. Based on requirement/capability of the target receiver, the CPU 330 configures the identification filter 310. The identification filter 310 receives a transport steam from the first network (in this embodiment, it receives the transport stream from a cable). As mentioned above, the identification filter 310 filters out unselected PID streams according to an identification configuration. For example, a transport packet may carry audio information corresponding to different languages or other programs. If some of the languages/programs are unselected, the identification filter 310 can filter out the transport packets that carry the unselected languages/programs.

Please note that the CPU 330 prepares updated identification information, which comprises the PMT and PAT complying with the requirement/capability of the computer system (the second network) 360. The CPU 330 controls the DMA controller 350 to store the updated identification information in the memory 320 for further operations.

The identification filter 310 outputs the selected PID stream to the pattern detector 340. The pattern detector 340 detects the selected PIDs, and exchanges the original identification information with the updated identification information, which has been prepared and stored in memory 320 (Step 420).

The pattern detector 340 then utilizes the updated identification information stored in the memory 320 to exchange the selected PID stream. Therefore, the exchanged PID stream then complies with the requirement/capability of the computer system 360. The unselected PID stream could bypass to the computer system 360 without the exchanging operation. These unselected PID streams might be PID streams containing video, audio, and regarded as unnecessary due to the identification configuration.

Both the operations of by-passing and exchanging are on a byte by byte basis there is no delay or jitter introduced. Exchanged PID stream and unselected PID stream then forward to the computer system 360 through a known interface (e.g. an IEEE 1394 interface or USB interface). There is no delay or jitter introduced (Step 440). Therefore, the computer system can correctly show TV program/channel as being selected.

For example, in the present invention, the CPU 330 can prepare the updated identification information also the identification configuration comprising a table of PID list (not shown) based on the program information of the incoming transport stream and the requirement/capability of the target receiver. The pattern detector 340 only has to detect whether the detected PID matches the PID in the table. If the detected PID matches the PID in the table, the pattern detector 340 directly exchanges the original identification information of the transport steam with the updated identification information. For example, the pattern detector 340 can directly exchange only a few bits/bytes of the transport packet or whole packet. In the above-mentioned operation, the CPU 330 only has to prepare the updated identification information without involvement in the exchanging operation. This makes the whole inter-network packet modifier 300 more efficient. Furthermore, because the transport stream can be in time exchanged by the pattern detector 340 instead of by the CPU 330, the output rate of the transport stream can equal to the input rate of the transport stream. This can significantly prevent the jitter problem.

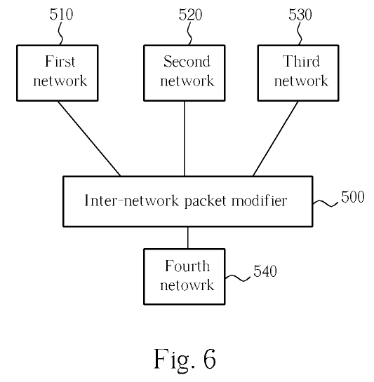

In this embodiment of the present invention, one inter-network packet modifier operates between two networks. In other embodiments of the invention, multiple networks may connect through one inter-network packet modifier. This also follows the spirit of the present invention. Please refer to FIG. 6, which is an inter-network packet modifier 500 of a second embodiment according to the present invention. As shown in FIG. 6, the inter-network packet modifier 500 is coupled to the first network 510, the second network 520, the third network 530, and the fourth network 540. The inter-network packet modifier 500 is utilized to perform the above-mentioned identification information exchanging process. The operation and function of the inter-network packet modifier 500 is similar to the operation of the inter-network packet modifier 300 for two networks. The only difference is that the inter-network packet modifier 500 needs to know the system requirement/capability of each network, both for the sources and receiving sides. For example, identification information as the PAT and the PMT may be exchanged according to the requirement of each receiving network. The corresponding functional adjustment is well known by those skilled in the art, and thus omitted here.

Please note that the above-mentioned identification filter is only utilized as a preferred embodiment, not a limitation. As known by those skilled in the art, a MAC filter can also be utilized. The MAC filter can filter out unwanted packets and exchange target information according to its sources and receiving specification. This also obeys the spirit of the present invention.

Please note that the computer system is only utilized as an embodiment, not a limitation. In the actual implementation, the present invention can be utilized in a display device (like 1394,USB or any other device which connects to this exchange device).

Please note that the above-mentioned inter-network packet modifier can be utilized in a set top box. Furthermore, it can be utilized in other Digital TV applications in order to improve the efficiency of the inter-network communication.

In contrast to the related art, the present invention inter-network packet modifier and related method can utilize a dedicated pattern detector to exchange the identification information of a transport packet. (Please note that the exchanging logic can exchange several packets based on requirements such as multiple networks—for example, in FIG. 6 one PMT needs to be exchanged for three sources and three different PATs need to be exchanged for each network program) Therefore, the present invention can avoid the jitter problem and improve/provide the quality of the signal stability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inter-network packet modifier coupled between a first network and a second network for receiving a first transport stream from the first network and generating a second transport stream outputted to the second network, the inter-network packet modifier comprising:
a storage device for storing an updated identification information; and
a pattern detector for detecting a specific pattern of the first transport stream and for detecting the specific pattern to exchange an original identification information of the first transport stream with the updated identification information according to an identification configuration to form the second transport stream;
wherein the pattern detector is a dedicated hardware for packet exchanging.

2. The inter-network packet modifier of claim 1, further comprising:
a controller for controlling the storage device for storing the updated identification information.

3. The inter-network packet modifier of claim 1, wherein the first transport stream complies with MPEG-2 standard.

4. The inter-network packet modifier of claim 3, wherein the specific pattern is a program identifier (PID) corresponding to a specific type of data contained in the first transport stream.

5. The inter-network packet modifier of claim 4, wherein the specific type of data is PAT.

6. The inter-network packet modifier of claim 4, wherein the specific type of data is PMT.

7. The inter-network packet modifier of claim 3, wherein both the original identification information and the updated identification information respectively comprises a corresponding program association table (PAT).

8. The inter-network packet modifier of claim 3, wherein both the original identification information and the updated identification information respectively comprises a corresponding program map table (PMT).

9. The inter-network packet modifier of claim 1, wherein the inter-network packet modifier is utilized in a set-top box.

10. The inter-network packet modifier of claim 1, further comprising:
an identification filter coupled between the pattern detector and the first network for allowing selected transport packets of the first transport stream to reach the pattern detector according to the identification configuration.

11. An inter-network packet modifying method for generating an outgoing transport packet forwarded to a second network according to an incoming transport stream received from a first network, the inter-network packet modifying method comprising:
providing an inter-network packet modifier comprising a storage device and a pattern detector;
utilizing the storage device to store an updated identification information; and
utilizing the pattern detector to detect a specific pattern of an incoming transport packet of the incoming transport stream and to exchange an original identification information of the incoming transport packet with the updated identification information according to the specific pattern to generate an outgoing transport packet of the outgoing transport stream;
wherein the pattern detector is a dedicated hardware for identification information exchanging.

12. The inter-network packet modifying method of claim 11, further comprising:
controlling the storage device for storing the updated identification information.

13. The inter-network packet modifying method of claim 11, wherein the transport stream complies with MPEG2 standard.

14. The inter-network packet modifier of claim 13, wherein the specific pattern is a program identifier (PID) corresponding to a specific type of data contained in the first transport stream.

15. The inter-network packet modifier of claim 14, wherein the specific type of data is PAT.

16. The inter-network packet modifier of claim 14, wherein the specific type of data is PMT.

17. The inter-network packet modifying method of claim 13, wherein both the original identification information and the updated identification information respectively comprises a corresponding program association table (PAT).

18. The inter-network packet modifying method of claim 13, wherein both the original identification information and the updated identification information respectively comprises a corresponding program map table (PMT).

19. The inter-network packet modifying method of claim 11, being utilized in a set-top box.
